(19) United States
(12) Patent Application Publication
(10) Pub. No.: US 2013/0234358 A1
(43) Pub. Date: Sep. 12, 2013

(54) Method for manufacturing profiled strips and hollow profiled bodies and a device for implementing the method

(71) Applicant: GM GLOBAL TECHNOLOGY OPERATIONS LLC, Detroit, MI (US)

(72) Inventors: Udo MILDNER, Limburg (DE); Lothar TESKE, Aschaffenburg (DE)

(73) Assignee: GM GLOBAL TECHNOLOGY OPERATIONS LLC, Detroit, MI (US)

(21) Appl. No.: 13/779,283

(22) Filed: Feb. 27, 2013

(30) Foreign Application Priority Data
Mar. 8, 2012 (DE) 10 2012 004 826.2

(51) Int. Cl. B29C 53/00

(52) U.S. Cl. CPC B29C 53/00
USPC 264/145; 425/112

(57) ABSTRACT

A method for manufacturing profiled strips is provided. The method includes providing an organic sheet band and heating the organic sheet band to a deformation temperature while feeding the organic sheet band through profiling rollers. The organic sheet band is profiled by the profiling rollers while feeding the organic sheet band through the profiling rollers to produce a roller-profiled organic sheet band. The roller-profiled organic sheet band is cut to a specified profiled strip length to form roller-profiled organic sheet band strips.

### CROSS-REFERENCE TO RELATED APPLICATION

This application claims priority to German Patent Application No. 10 2012 004 826.2, filed Mar. 8, 2012, which is incorporated herein by reference in its entirety.

### TECHNICAL FIELD

Described is a method for manufacturing profiled strips and hollow profiled bodies, in particular a method for manufacturing profiled strips and hollow profiled bodies for vehicles, and a device for implementing the method.

### BACKGROUND

Known from publication DE 196 35 357 A1 is a method and a tool system for manufacturing profiles reinforced with continuous filaments. The known method is used to manufacture fiber-reinforced extruded profiles from a plastic matrix with embedded aluminum fibers. Extrusion already yields the profile comprised of a plastic material, preferably a thermoplastic, and longitudinal fibers are then fused into the extruded profile with the extrusion process still ongoing.

Known from publication DE/EP 0 093 748 T1 is a method and device for manufacturing profiles out of fiber-reinforced, thermoplastic resin and profiles manufactured in this way. To this end, the publication discloses a method for manufacturing thin profiled parts comprised of continuously unidirectional fibers, which are embedded in a thermoplastic resin, in which a web of parallel fibers is impregnated with resin particles, after which the resin is melted, and the profiled part is formed and cooled.

For this purpose, the fiber web is immersed in a bath comprised of resin particles, and the particles are mechanically induced to penetrate into the web, wherein the excess particles are removed to achieve the desired percentage of resin in relation to the fibers. Cylinders or rollers are used to mechanically press the resin particles into a web comprised of fibers, and the rolled-in resin is melted, after which the fiber-reinforced plastic band is formed into a band between two cooled cylinders.

At least one object herein is to provide a method and device for cost-effectively manufacturing profiled strips and hollow profiled bodies for vehicles out of a fiber-reinforced plastic band. In addition, other objects, desirable features and characteristics will become apparent from the subsequent summary and detailed description, and the appended claims, taken in conjunction with the accompanying drawings and this background.

### SUMMARY

An example for implementing the method for manufacturing profiled strips exhibits the following steps. An organic sheet band is first prepared. The organic sheet band is then heated to a deformation temperature while being fed through. The organic sheet band is thereafter profiled by means of profiling rollers while being fed through. The roller-profiled organic sheet band can finally be cut to a specified profiled strip length.

Organic sheet denotes a fiber-reinforced plastic, which is shaped like a sheet due to its dimensions.

With this method, nearly any number of profiled strips can be cost-effectively manufactured while being processed. However, a plurality of roller stages in corresponding profile roller chambers is used for roller profiling. But the method makes it possible to fabricate any number of varying cross sectional profiles. Several possible cross sectional profiles will be described in more detail in the attached figures. To this end, profiling takes place in several roller profiling stages until such profiles have been fabricated.

In an exemplary embodiment, in order to fabricate profiled components in any embodiment desired and in any cross sectional profile out of organic sheet, roller forming tools are incorporated into the profiling chambers, and a heating furnace is connected upstream at least in a first heating chamber, wherein additional intermediate heating chambers with corresponding heating furnaces can be interspersed, depending on the length of the necessary roller forming tools or number of necessary roller profiling stages.

During roller profiling, the organic sheet bands, which are films comprised of thermoplastic continuously fiber-reinforced with carbon, glass or aramite fibers, are kept in a softening temperature range of the thermoplastic, for example, lying in a range of from about 150° C. to about 350° C., so that a suitable deformation temperature range measures from about 200° C. to about 300° C.

Another embodiment provides that a partially roller-profiled organic sheet band is intermediately heated between the roller profiling stages once a prescribed deformation temperature threshold has been reached during the multistage roller profiling process. The deformation temperature threshold for intermediate heating is about 5° C. higher than the lower softening temperature of the organic sheet band.

In another embodiment, the organic sheet band is wound onto an organic sheet band coil as a prepreg semi-finished product, and is unwound from such an organic sheet band coil during the continuous process.

Another embodiment provides that reinforcement ribbing initially is incorporated into the organic sheet band after heating and before multistage roller profiling, so as to elevate the dimensional stability of the profiled strip.

The profiles comprised of organic sheet bands fabricated with the roller forming method exhibit a flexible shaping at a high stiffness. In addition, it is possible to fabricate a respectively closed profiled box for hollow profiled bodies or hollow profiled beams for vehicle bodies out of two organic sheet profiled bands via welding. To this end, known welding procedures like friction welding, vibration welding and/or electromechanical powder welding can be used. This makes it possible to cost-effectively prepare hollow profiles for vehicle construction.

One basic advantage to using organic sheets as profiled strips or hollow profiles in motor vehicle construction lies in the reduced weight, which advantageously brings with it a decreased fuel consumption for motor vehicle operation. Also advantageous is that fabrication is more cost-effective by comparison to the previously used deep-drawing methods for generating profiled strips for motor vehicle construction.

In an exemplary embodiment, a device for implementing a method for manufacturing profiled strips or hollow profiled bodies for vehicles of the kind described above exhibits at least one heating chamber with an area for receiving an organic sheet band from an organic sheet band coil. The device further exhibits at least one profiling chamber with at least one roller profiling stage. Finally, a cutter is built onto the device for cutting a roller-profiled extruded profile to a prescribed profiled strip length while removing the extruded profile from the profiling chamber.

With such a device, a plurality of profiled strips can be manufactured as they are fed through the device, without requiring dies or extrusion dies.

In addition, the device can exhibit a first roller profiling chamber and a second roller profiling chamber, between which is situated an intermediate heating chamber to ensure that the deformation temperature does not drop below a threshold deformation temperature. This threshold deformation temperature depends on the lowest softening temperature of the organic sheet band, and, in an embodiment, is at least about 5° C. higher than this lower softening temperature TuE.

In another embodiment, instead of a first and second profiling chamber, the device can exhibit as many profiling chambers are desired, which each have arranged between them an intermediate heating chamber, so as to keep the organic sheet temperature within the required deformation temperature range during roller deformation, for example, at about 150° C.—TV—350° C., such as about 200°≦TV≦300° C.

In order to test, determine and regulate the temperature, each of the chambers can exhibit corresponding temperature sensors, so that the organic sheet remains within the softening temperature range of the thermoplastic while being processed.

### BRIEF DESCRIPTION OF THE DRAWINGS

The various embodiments will hereinafter be described in conjunction with the following drawing figures, wherein like numerals denote like elements, and wherein:

FIG. 1 is a schematic diagram of the method for manufacturing profiled strips out of an organic sheet band, in accordance with an exemplary embodiment;

FIG. 2 is a schematic, perspective view of a device for manufacturing profiled strips out of an organic sheet band, in accordance with an exemplary embodiment;

FIG. 3 includes FIGS. 3a and 3b, which are schematic views an organic sheet band with an organic sheet band width roller profiled into a profiled strip with a profile circumference, in accordance with exemplary embodiments;

FIG. 4 includes FIGS. 4a to 4f, which are schematic cross sections of roller profiled profiles strips, in accordance with exemplary embodiments; and

FIG. 5 includes FIGS. 5a and 5b, which are cross-sectional views of hollow profiled bodies manufactured out of roller profiled strips, in accordance with exemplary embodiments.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

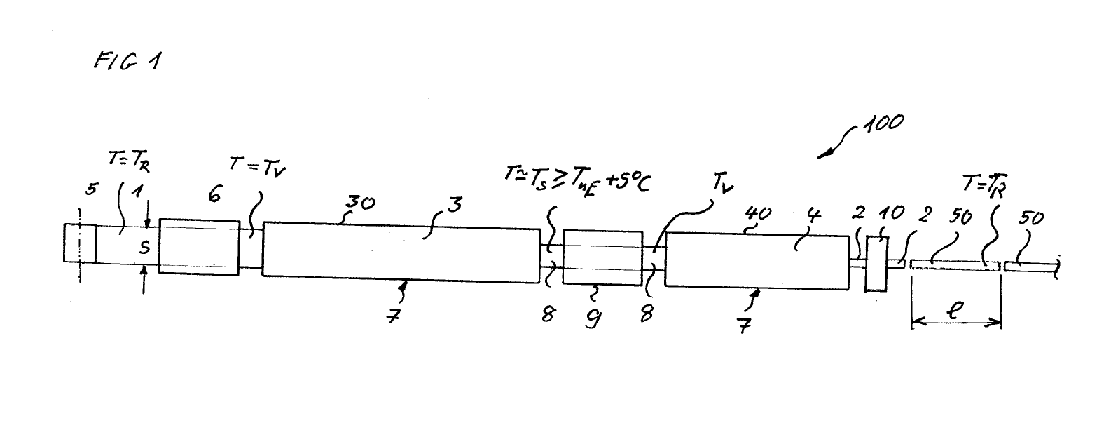

FIG. 1 presents a schematic diagram of a method for manufacturing profiled strips 50 out of an organic sheet band 1 in accordance with an exemplary embodiment. The organic strip band 1 is a semi-finished product of continuous strand-reinforced thermoplastic with an organic sheet band width s, which corresponds to the profile circumference of the profiled strip 50, and an organic sheet band thickness d, as depicted in the following figures. While the organic sheet band width s depends on the profile circumference of the profiled strip 50 to be manufactured or a hollow profiled body to be manufactured, the organic sheet band thickness d ranges from about 0.5 mm to about 3 mm. Such an organic sheet band 1 can be deformed at a temperature TV in the range of about 150° C. to about 350° C. To this end, the organic sheet band 1 is passed through a heating chamber 6 while being processed, and heated to the required deformation temperature. The heated organic sheet band then passes through roller tools in a profiling chamber 30, which can comprise several profiling stages 3, until the at least partially roller profiled organic sheet band 8 has dropped to a threshold deformation temperature TS at least about 5° C. higher than the lowest softening temperature TuE of the thermoplastic of the organic sheet band at T>TS=TuE+about 5° C.

In an embodiment, if the profile has already been completely roller profiled before this threshold deformation temperature TS has been reached, the roller-profiled extruded profile 2 is separated into profiled strips already after a single roller profiling chamber 7. However, if additional roller profiling tools or roller profiling stages 4 are needed, the partially roller-profiled extruded profile 8 is heated in an intermediate heating chamber 9 to the deformation temperature TV in the aforementioned temperature range, and passed through the other roller profiling stages 4 in another, second roller profiling chamber 40.

In another embodiment, if the end profile of the profiled strip 50 is reached after the second roller profiling chamber 40, the roller-profiled organic sheet band 2 is cut in an adjoining cutting device 10 to the profiled strip lengths 1, and the profiled strip 50 can be cooled down to room temperature T=TR. The organic sheet band 1 can continue to be fed through and formed into the roller-profiled organic sheet band 2 until the organic sheet band coil 5 has been completely unwound.

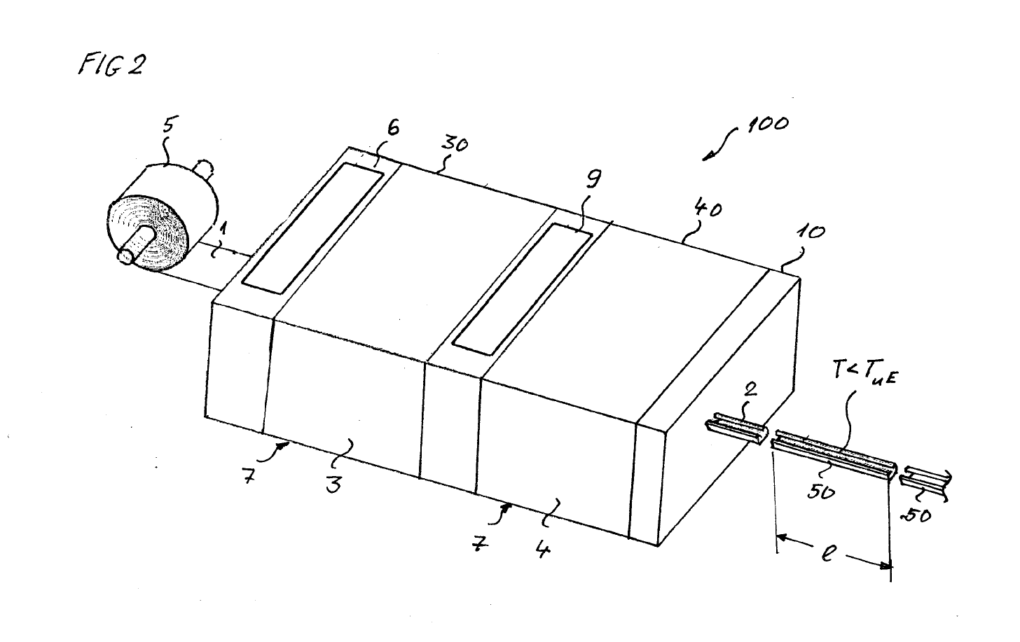

FIG. 2 presents a schematic, perspective view of a device 100 for manufacturing profiled strips 50 out of an organic sheet band 1, which is wound off of an organic sheet band roller 5 and fed to the first heating chamber 6 of the housing

In accordance with an exemplary embodiment, in order to economize on energy in this device 100, the heating chambers 6 and 9 along with the profiling chambers 30 and 40 are accommodated in a single housing with the adjacent cutting device 10. Each heating chamber 6 or 9 can incorporate thermocouples, so as to maintain a constant prescribed deformation temperature of the heating chambers. In addition, temperature sensors are provided inside the profiling chambers 30 and 40, and respectively monitor the temperature of the organic sheet band during roller profiling. Cutting to the corresponding length 1 of the profiled strips 50 for a vehicle can only take place once the temperature in the cutting device has dropped below the lower softening temperature value of TuE at T<TuE.

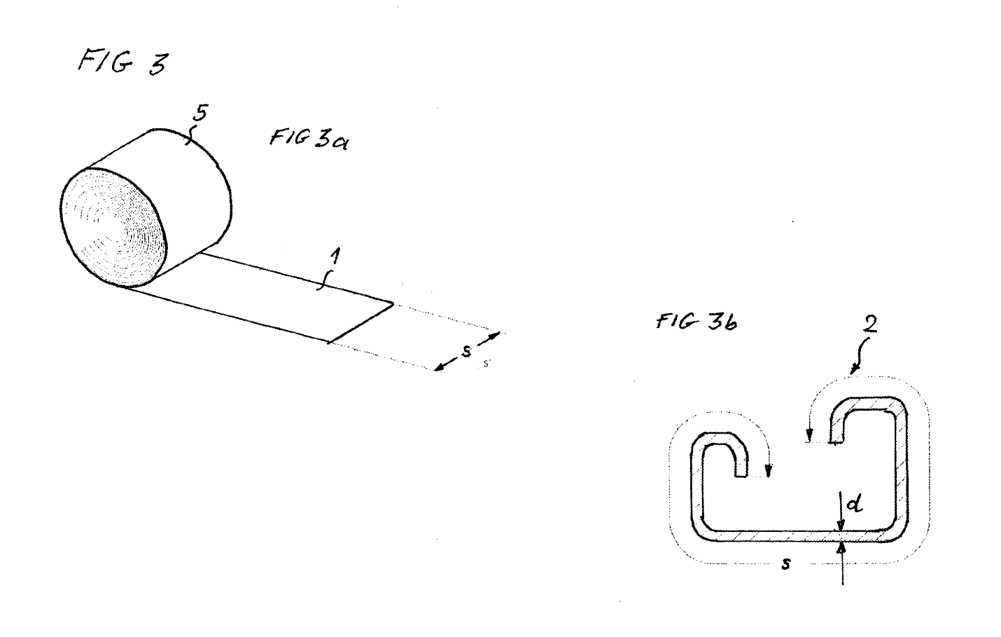

FIGS. 3a and 3b of FIG. 3 present a schematic view of how an organic sheet band 1 with an organic sheet band width s is roller profiled into a profiled strip with a profile circumference s. The organic sheet band is wound onto an organic sheet band coil 5 in organic sheet band width s, and is wound off of the latter for roller profiling as depicted on FIG. 3a.

FIG. 3b shows the profile of the roller profiled organic sheet band 2 generated via roller profiling, wherein the profile circumference s is equal to the organic sheet band width s, and the organic sheet has a thickness d in the range of about 0.5 mm to about 3 mm.

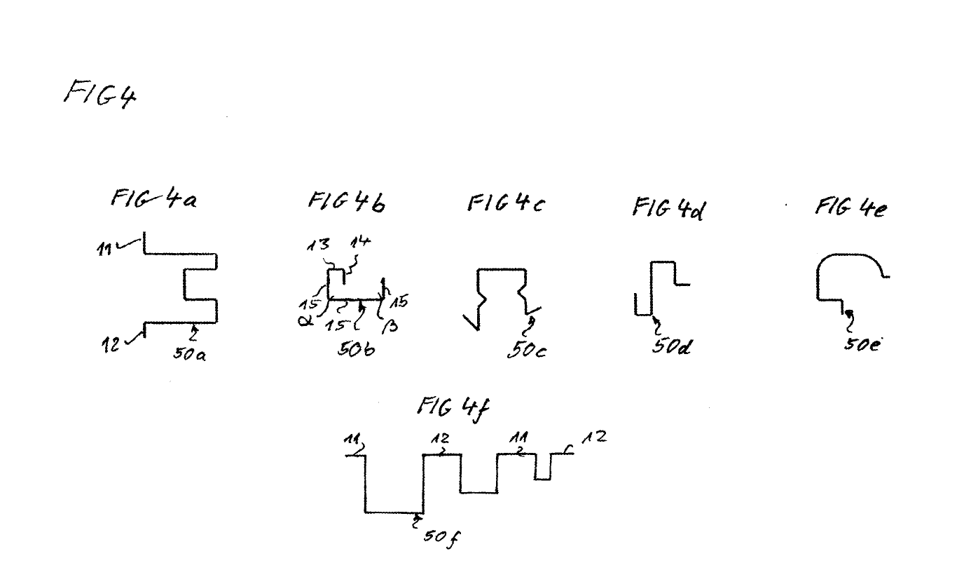

FIGS. 4a to 4f of FIG. 4 present schematic cross sections of roller profiled strips 50a to 50f, according to various embodiments.

The profile of the profiled strip 50a on FIG. 4a can already be achieved with only a single roller profiling stage by drawing the heated organic sheet band between two corresponding profile rollers. The profile on FIG. 4a can simultaneously be used as a half profile for a hollow profiled body by integrally joining two of these profiles depicted on FIG. 4a with their flange surfaces 11 and 12. Such an integral bond can be achieved by welding or adhesively joining the flange surfaces 11 and 12 of two profiled strips 50a.

The profile of the profiled strip 50b on FIG. 4b can be realized in three roller profiling stages, wherein a U-shaped area 13 with a short leg 14 and a long leg 15 are created in a first roller profiling stage. The long leg 15 is subsequently chamfered in a second roller profiling stage at a first chamfering angle α of about 90°, and the second chamfering angle β is then also realized in a third roller profiling stage at about 90°.

Distinctly more roller profiling stages are required for the profile of a profiled strip 50c shown on FIG. 4c, while the profile of a profiled strip 50d depicted on FIG. 4d can practically be realized in a single roller profile stage. The profile of the profiled strip 50e on FIG. 4e can also be realized using three roller profiling stages.

While the profile of a profiled strip 50f depicted on FIG. 4f can in turn be realized with just a single roller profiling stage, a significantly wider organic sheet band 1 is here suitable to provide a profile for a profiled strip 50f that can simultaneously also serve as a semi-finished product for manufacturing three hollow body profiles with three different cross sections for the hollow body. In this case as well, the flange surfaces 11 and 12 can be used to generate a correspondingly adjusted second profiled strip for integrally joining the flange surfaces 11 and 12 in order to manufacture hollow profiled strips or hollow profiled beams with the strip 50f depicted on FIG. 4f.

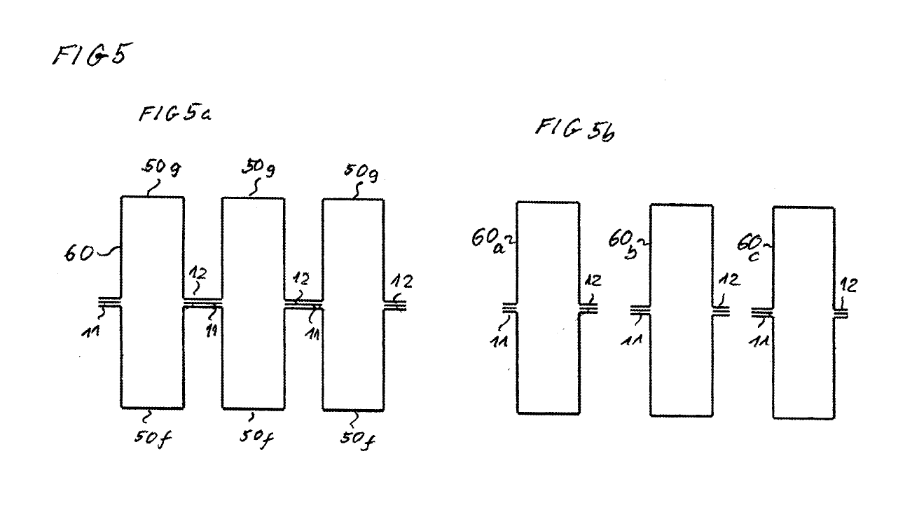

FIGS. 5a and 5b of FIG. 5 show how hollow profiled bodies 60 are manufactured out of roller profiled strips 50 in an exemplary embodiment.

Fabricated to this end as shown on FIG. 5a is a first profiled strip 50f with three U-shaped areas, and a uniform profiled strip 50g also with three U-shaped bulges, wherein each of the profiled strips 50f and 50g exhibits flange surfaces 11 and 12 that are integrally joined together to form the hollow profiled bodies 60a, 60b and 60c depicted on FIG. 5b. This integral bond can be a welded or adhesive bond, wherein the three hollow profiled bodies 60a, 60b and 60c can subsequently be formed by dividing up the hollow body 60 depicted on FIG. 5a to form individual hollow profiled bodies, e.g., for hollow profiled beams in vehicle construction.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A method for manufacturing profiled strips, the method comprising the steps of:
providing an organic sheet band;
heating the organic sheet band to a deformation temperature while feeding the organic sheet band through profiling rollers;
profiling the organic sheet band by the profiling rollers while feeding the organic sheet band through the profiling rollers to produce a roller-profiled organic sheet band; and
cutting the roller-profiled organic sheet band to a specified profiled strip length to form roller-profiled organic sheet band strips.

2. The method according to claim 1, wherein profiling takes place in several roller profiling stages.

3. The method according to claim 2, wherein a partially roller profiled organic sheet band is intermediately heated between roller profiling stages until a prescribed deformation temperature threshold has been reached.

4. The method according to claim 3, wherein the deformation temperature threshold for intermediate heating is about 5° C. higher than a lower softening temperature of the organic sheet band.

5. The method according to claim 1, wherein the organic sheet band is wound from an organic sheet band coil as a prepreg semi-finished product.

6. The method according to claim 1, wherein reinforcement ribbing is initially incorporated into the organic sheet band after heating and before profiling.

7. The method according to claim 2, wherein the organic sheet band is profiled at a deformation temperature TV in the range of from about 150° C. to about 350° C.

8. The method according to claim 7, wherein the organic sheet band is profiled at a deformation temperature TV in the range of from about 200° C. to about 300° C.

9. The method according to claim 1, wherein a ribbon-like, glass-fiber reinforced thermoplastic is profiled as the organic sheet band.

10. The method according to claim 1, wherein a ribbon-like, carbon-fiber reinforced thermoplastic is profiled as the organic sheet band.

11. The method according to claim 1, wherein hollow profiled bodies are fabricated by joining the roller-profiled organic sheet band strips.

12. A device for manufacturing profiled strips for vehicles, the device comprising:
a heating chamber with an area for receiving an organic sheet band from an organic sheet band coil;
at least one profiling chamber, with several roller profiling stages, for receiving the organic sheet band from the heating chamber; and
a cutting device for cutting a roller profiled extruded profile to a prescribed profiled strip length while removing the extruded profile from the at least one profiling chamber.

13. The device according to claim 12, wherein the device has a first roller profiling chamber and a second roller profiling chamber, between which is situated an intermediate heating chamber.

15. The device according to claim 12, wherein the heating chamber and the at least one profiling chamber comprise temperature sensors to monitor and regulate the degree to which the organic sheet band is softened in the at least one roller profiling chamber.
